(19) United States
(12) Patent Application Publication
(10) Pub. No.: US 2011/0011427 A1
(43) Pub. Date: Jan. 20, 2011

(54) CLEANING SYSTEM

(75) Inventor: Yasuyoshi Shimizu, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: INFINITY ENTRPRISES, INC., SHIBUYA-KU (JP)

(21) Appl. No.: 12/736,341

(22) PCT Filed: Apr. 1, 2009
(86) PCT No.: PCT/JP2009/056802

§ 371 Date: Sep. 30, 2010

(30) Foreign Application Priority Data
Apr. 2, 2008 (JP) 2008-095694

(51) Int. Cl. B08B 3/00

(52) U.S. Cl. 134/105

(57) ABSTRACT

To provide a cleaning system performing a cleaning of a work after UV paint or the like used, for example, in baking coating or the like thereon has been completely dried, through use of a vegetable cleaning solution heated to a temperature equal to or higher than a flash point. A cleaning solution A put in a cleaning bath 16 is heated by a heater unit 15. A work 5 which has been used and has a coating film adhered thereto and completely cured is put into the heated cleaning solution A, and the cleaning is performed. As a result, the coating film adhered to the work is substantially completely cleaned.

### TECHNICAL FIELD

The present invention relates to a cleaning system performing a cleaning of a work after it is completely dried to which, for example, UV paint or the like is adhered by using a cleaning solution.

### BACKGROUND

Conventionally, a combustible vegetable cleaning solution (for example, PAINTSOLV® manufactured by Infinity and so on) is used to clean paint adhered to a work such as, for example, a paint hanger. At this time, a method in which the vegetable cleaning solution is heated to clean is taken when a stain is particularly difficult to clean. However, the vegetable cleaning solution is combustible as same as thinner or the like, so vaporized combustible gas is generated if it is heated over a flash point, and there is a possibility that it takes fire. Accordingly, a usable temperature is equal to or lower than the flash point. For example, the flash point of the above-stated PAINTSOLV® manufactured by Infinity is 178° C., and therefore, the vegetable cleaning solution is actually used while setting a temperature at approximately 20° C. lower than the flash point as an upper limit temperature because an error and so on in temperature detection is taken into account.

### DISCLOSURE OF INVENTION

### Problems to be Solved by the Invention

When a cleaning of general urethane paint, epoxy paint, or acrylic paint is performed, the above-stated vegetable cleaning solution is used at the temperature equal to or lower than the flash point, and thereby, the cleaning of the above-stated paints before they are completely dried can be performed without any problems. However, cleaning power of the vegetable cleaning solution used at the temperature equal to or lower than the flash point is not enough as for the cleaning of the urethane paint, the epoxy paint, the acrylic paint, or the like after they are completely dried used for a baking finish and so on. Further, it is totally impossible to obtain a cleaning effect by using the vegetable cleaning solution at the temperature equal to or lower than the flash point as for a cleaning of UV paint (ultraviolet curing paint) after it is completely dried. Under the present situation, the cleaning of the UV paint after it is completely dried is difficult even if harmful and dangerous solvent such as thinner is used, so there is no effective cleaning means and only a method in which a film is hit with a hammer is taken. Besides, the paint adhered to a jig and so on such as a bar-shaped metal hanging a paint object called as a paint hanger in a paint booth cannot be completely cleaned even though it is cleaned with thinner because coating films for several dozen times are adhered thereto. Besides, there also is a problem in which a completely dried adhesive cannot be completely cleaned.

In consideration of the above-stated problems, an object of the present invention is to provide a cleaning system performing a cleaning of a work with, for example, the UV paint or the like after it is completely dried by using a vegetable cleaning solution heated to a temperature equal to or higher than a flash point.

### Means for Solving the Problems

According to the present invention, a cleaning system cleaning paint adhered to a work, includes: a cleaning tank housing the work under a sealed state, and in which a cleaning solution is filled; and a heater heating the cleaning solution filled in the cleaning tank to a temperature equal to or higher than a flash point of the cleaning solution is provided.

The cleaning system may include: a distillation and regeneration mechanism distilling and regenerating the cleaning solution. Besides, a cooling tube cooling the cleaning solution filled in the cleaning tank may be included.

The cleaning system may include: an auxiliary tank storing the cleaning solution; and a circulation mechanism circulating the cleaning solution between the cleaning tank and the auxiliary tank.

The circulation mechanism may include: a forward flow path carrying the cleaning solution from the auxiliary tank to the cleaning tank; and a return flow path carrying the cleaning solution from the cleaning tank to the auxiliary tank, in which the auxiliary tank may be disposed at downward of the cleaning tank, and may include a solution sending mechanism carrying the cleaning solution from the auxiliary tank to the cleaning tank.

### Effect of the Invention

According to the present invention, a cleaning of a work can be performed by means of a cleaning system performing the cleaning of the work with, for example, a completely dried UV paint or the like by using a vegetable cleaning solution heated to a temperature equal to or higher than a flash point.

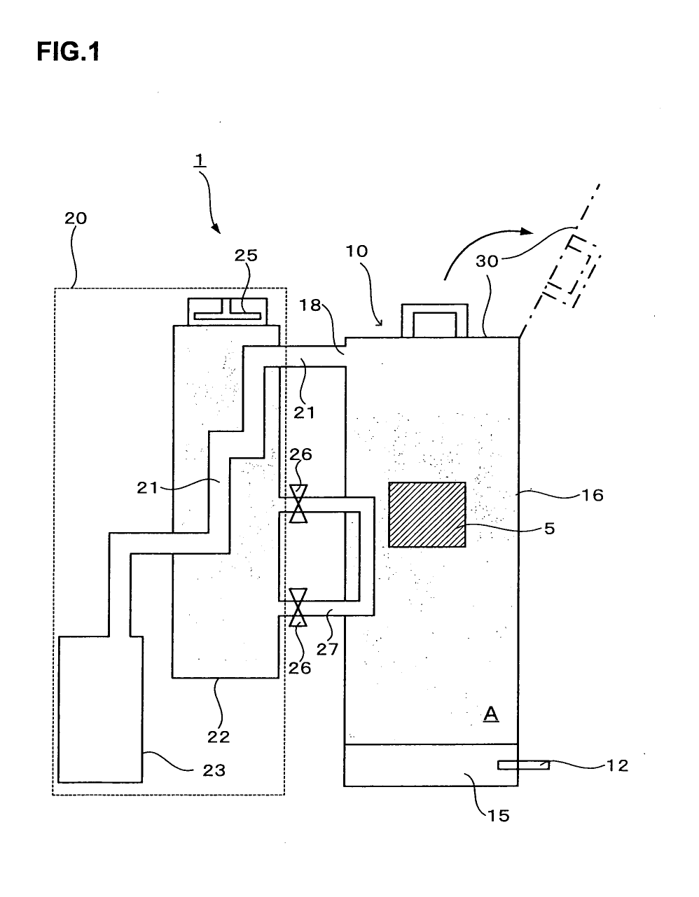

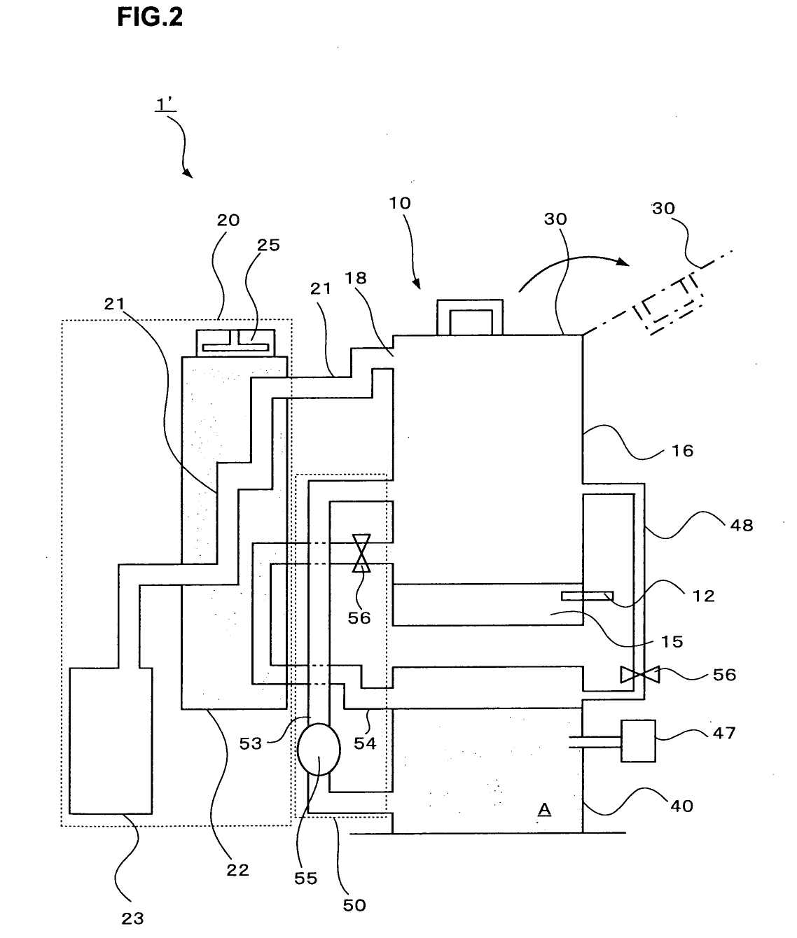

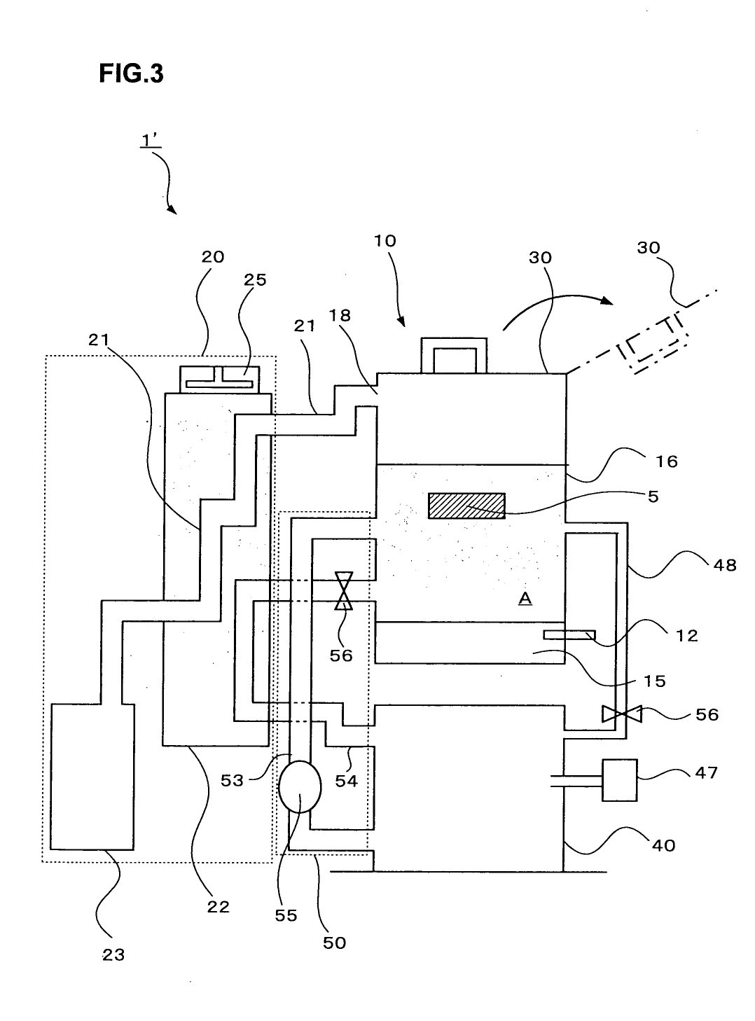

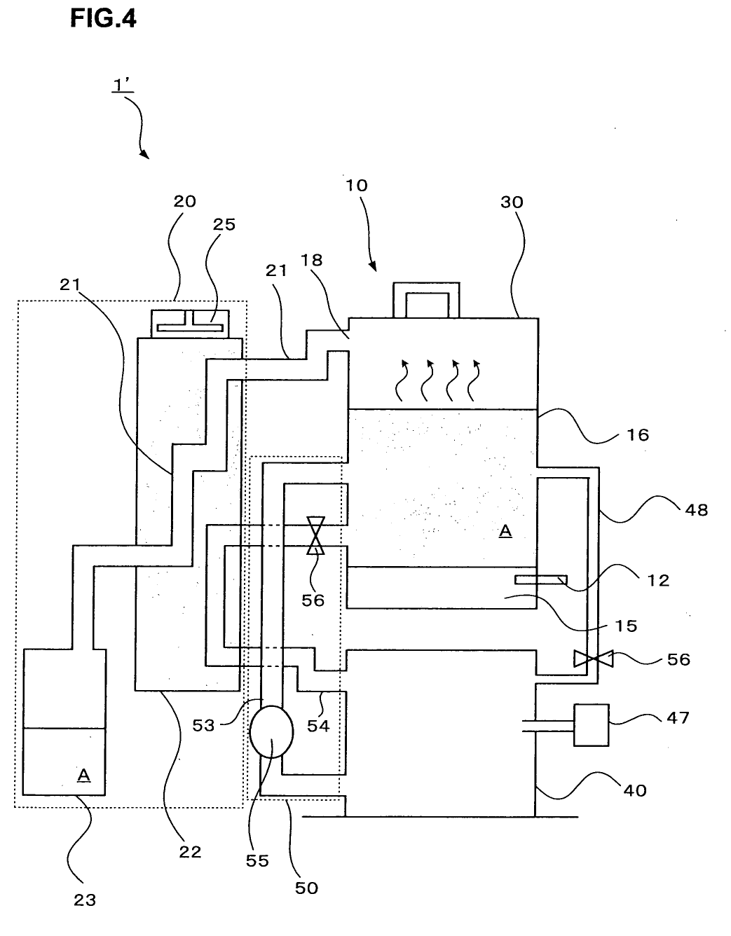

### BRIEF DESCRIPTION OF THE DRAWING

[FIG. 1] A cross sectional schematic diagram of an appearance of a cleaning system 1 at a cleaning time seeing from the side.

[FIG. 2] A cross sectional schematic diagram of an appearance of a cleaning system 1′ according to another embodiment before a cleaning seeing from the side.

[FIG. 3] A cross sectional schematic diagram of the cleaning system 1′ at a cleaning time of a work 5.

[FIG. 4] An explanatory diagram illustrating an appearance of a cleaning solution A at a distillation and regeneration time at the cleaning system 1′.

### EXPLANATION OF CODES

1, 1′ cleaning system

5 work

10 cleaning tank

12 temperature sensor

15 heater unit

16 cleaning bath

18 gas recovery hole

20 distillation and regeneration mechanism

21 distillation tube

22 cooling tank

23 distillation tank

25 cooling fan

26 water shut-off valve

27 cooling tube

30 lid

40 auxiliary tank

47 compressed air introducing mechanism

48 air pipe

50 circulation mechanism

53 forward flow path

54 return flow path

55 high-temperature pump

56 valve

A cleaning solution

### BEST MODE FOR CARRYING OUT THE INVENTION

Hereinafter, embodiments of the present invention are described with reference to the drawings. Note that the same reference symbols and numerals are used to designate components having the same and corresponding functional configuration in the present specification and the drawings, and the redundant description thereof will not be given.

FIG. 1 is a cross sectional schematic diagram of an appearance of a cleaning system 1 according to the present invention at a cleaning time seeing from the side. The cleaning system 1 is made up of a cleaning tank 10 housing and cleaning a work 5 and a distillation and regeneration mechanism 20 being communicated with the cleaning tank 10. Constitutions of respective parts are described below.

A heater unit 15 including a temperature sensor 12 is provided at the cleaning tank 10, and the cleaning tank 10 can be appropriately heated to a preset temperature. At the cleaning tank 10, a cleaning bath 16 is provided at an upper portion of the heater unit 15, and the work 5 is housed and a cleaning solution A is filled therein at the cleaning time. Besides, a lid 30 openable and closeable, capable of sealing the cleaning bath 16, with a seal composed of, for example, silicon is provided at an upper portion of the cleaning bath 16.

Besides, a gas recovery hole 18 is provided at an upper portion of the cleaning tank 10, and the gas recovery hole 18 is communicated with the distillation and regeneration mechanism 20 via a distillation tube 21. The distillation and regeneration mechanism 20 is made up of a water-cooling type cooling tank 22 and a distillation tank 23, a cooling fan 25 is provided at an upper portion of the cooling tank 22, and the distillation tube 21 is passing through inside thereof. A cooling tube 27 passing through inside the cleaning bath 16 and having a water shut-off valve 26 is provided at the cooling tank 22. Cooling water of the water-cooling type cooling tank 22 is appropriately passing through the cooling tube 27 by opening/closing the water shut-off valve 26, and thereby, inside the cooling bath 16 can be cooled. The distillation tube 21 is communicated with the distillation tank 23.

The cleaning of the work 5 and distillation and regeneration of the cleaning solution A are performed as described below at the cleaning system 1 having the constitution as described above. At first, the cleaning solution A and the work 5 to which the coating film, the adhesive, and so on are adhered and completely cured are put into the cleaning bath 16 as illustrated in FIG. 1. The cleaning bath 16 is sealed by the lid 30 with the seal, and thereafter, the cleaning solution A is heated to a temperature over a flash point by the heater unit 15. After that, the cleaning of the work 5 is performed in the cleaning solution A heated to a predetermined temperature. The cleaning solution A is heated under a state in which the cleaning bath 16 is sealed, and therefore, it is possible to safely perform the cleaning of the work 5 even if the cleaning solution A is heated to a temperature near a boiling point.

Here, for example, PAINTSOLV® manufactured by Infinity being a vegetable cleaning solution is used as the cleaning solution A. The boiling point of the vegetable cleaning solution (PAINTSOLV® manufactured by Infinity) is at approximately 178° C., and it is preferable that the heating of the cleaning solution A (vegetable cleaning solution) by the heater unit 16 is performed up to approximately 170° C. to 178° C. being the temperature near the boiling point to effectively perform the cleaning of the work 5. Here, the cleaning temperature is preferable to be set at approximately 170° C. to 178° C. because the above-stated PAINTSOLV® manufactured by Infinity is used as the cleaning solution A, but it is desirable that the cleaning temperature is appropriately changed in accordance with types of the cleaning solution to be used and a coating cured film to be an object of the cleaning.

After the cleaning of the work 5 is finished, cooling water is introduced into the cooling tube 27 from the cooling tank 22 under the state in which the cooling bath 16 is sealed, and cooling of the cleaning solution A remained in the cleaning bath 16 after the cleaning is performed. The cooling of the work 5 after the cleaning immersed in the cleaning solution A is performed simultaneously by performing the cooling of the cleaning solution A after the cleaning as stated above. The cleaning solution A is cooled to the temperature lower than the flash point under a sealed state. After that, the lid 30 is opened and the work 5 is brought out. The cooling of the cleaning solution A is performed under the sealed state, and thereby, safety at the time when the work 5 after the cleaning is brought out is secured.

On the other hand, an equipment to reuse the cleaning solution A by performing the distillation and regeneration when the cleaning of the work 5 is performed is a distillation and regeneration mechanism 20. As stated above, the temperature in which the vegetable cleaning solution (PAINTSOLV® manufactured by Infinity) is vaporized (boiling point) is approximately 178° C., and when the cleaning is performed at the temperature of approximately 170° C. to 178° C. at the cleaning time of the work 5, the cleaning solution A is vaporized inside the cleaning bath 16.

When the cleaning solution A is heated at the cleaning bath 16 up to a degree of the temperature in which the cleaning solution A is vaporized when the work 5 is cleaned, the cleaning solution A is vaporized to be cleaning solution gas. At the cleaning time, the cleaning bath 16 is in the sealed state, and therefore, the cleaning solution gas is flowed out from the gas recovery hole 18 of the cleaning bath 16 to the distillation tube 21 because an internal pressure of the cleaning bath 16 increases. The flowed out cleaning solution gas is cooled and becomes liquid at the distillation tube 21 inside the cooling tank 22, and after that, it is stored in the distillation tank 23. Note that the cooling fan 25 is provided at the upper portion of the cooling tank 22, and the cooling up to a degree enough for liquifying the cleaning solution gas in the distillation tube 21 is performed inside the cooling tank 22. The cleaning solution A stored in the distillation tank 23 is the one which is distillated and regenerated, and it can be reused as the cleaning solution A.

It is possible to effectively perform the cleaning of the work 5 to which stains such as the coating cured film, the adhesive, and so on are adhered by performing the cleaning at high temperature if the cleaning system 1 according to the present embodiment is used. Here, various kinds of adhesives, cation electrodeposition coating, the coating cured film such as a coating for a golf club, and so on can be exemplified as the stains capable of being cleaned. Besides, the cleaning solution A which has been used for the cleaning of the work 5 becomes reusable by performing the distillation and regeneration, leading to a reduction of a cleaning cost.

Here, for example, a very expensive jig and component used for various paint works and adhesive works can be exemplified as the work 5. Conventionally, it is impossible to remove the paint and the adhesive up to the degree in which the reuse of these jig and component become possible. However, it becomes possible to reuse the jig and component and to enable the reduction of a manufacturing cost and so on because the paint and the adhesive adhered to these jig and component are effectively removed by using the cleaning system 1 according to the present invention.

Further, when there is a paint failure and so on in a product in which paint for metal is performed, the product with the paint failure is conventionally disposed. However, a beautiful and effective removal of the coating of such product with the paint failure becomes possible by using the cleaning system 1 according to the present invention. As a result, a disposal amount of the product is reduced, recoating efficiency increases, and leading to the reduction of the manufacturing cost.

Hereinabove, an example of the preferred embodiment of the present invention is described, but the present invention is not limited to the illustrated embodiment. It is obvious that those skilled in the art are able to figure out various changed examples or modified examples within the range of the following claims, and it is to be understood that all those changes and modifications are to be included in the technical scope of the present invention.

Hereinafter, a cleaning system 1′ according to another embodiment of the present invention is described with reference to the drawings. Note that the similar components as the cleaning system 1 according to the above-stated embodiment are described by using the same reference symbols and numerals, in the cleaning system 1′.

FIG. 2 is a cross sectional schematic diagram of an appearance of a cleaning system 1′ according to another embodiment before cleaning seeing from the side.

The cleaning system 1′ is made up of the cleaning tank 10 housing and cleaning the work 5, an auxiliary tank 40 storing the cleaning solution A, a circulation mechanism 50 circulating the cleaning solution A between the cleaning tank 10 and the auxiliary tank 40, and the distillation and regeneration mechanism 20 communicated with the cleaning tank 10. Constitutions of respective parts are described below. Here, the components other than the auxiliary tank 40 and the circulation mechanism 50 and the cleaning process of the work 5 are the same as the cleaning system 1 according to the above-stated embodiment, and therefore, the description is not given.

The auxiliary tank 40 is provided at downward of the cleaning tank 10 of the cleaning system 1′, and the circulation mechanism 50 is provided between the cleaning bath 16 and the auxiliary tank 40. The circulation mechanism 50 is made up of a forward flow path 53 carrying the cleaning solution A from the auxiliary tank 40 to the cleaning bath 16 and a return flow path 54 carrying the cleaning solution A from the cleaning bath 16 to the auxiliary tank 40. The forward flow path 53 includes a high-temperature pump 55, and the return flow path 54 includes a valve 56. Here, the return flow path 54 is passing through inside the cooling tank 22 described below. Besides, the auxiliary tank 40 is normally in the sealed state, and the cleaning solution A is stored therein. A compressed air introducing mechanism 47 is included at the auxiliary tank 40, and further, an air pipe 48 including the valve 56 for air evacuation at a compressed air introducing time is communicated from the auxiliary tank 40 to the cleaning bath 16.

FIG. 3 is a cross sectional schematic diagram of the cleaning system 1′ at the cleaning time of the work 5. When the cleaning of the work 5 is performed at the cleaning system 1′, the cleaning solution A stored in the auxiliary tank 40 beforehand is introduced into the cleaning bath 16 from the forward flow path 53 by the high-temperature pump 55 of the circulation mechanism 50. The cleaning solution A introduced into the cleaning bath 16 is heated by the heater unit 15 as same as the cleaning system 1 according to the above-stated embodiment. The cleaning of the work 5 is performed by putting the work 5 which has been used and has the coating film, the adhesive, and so on adhered thereto and completely cured into the heated cleaning solution A.

Here, a lot of time is required as a cool time if the cleaning solution A is cooled naturally in the cleaning bath 16 after the cleaning of the work 5. Accordingly, the heated cleaning solution A is moved to the auxiliary tank 40 via the return flow path 54 after the cleaning of the work 5 to effectively cool down the cleaning solution A, and the heated cleaning solution A is cooled at the auxiliary tank 40, in the cleaning system 1′ according to the present embodiment. At this time, the cleaning solution A is evacuated from the cleaning bath 16, and therefore, the cooling of the work 5 is also performed effectively. Note that the cooling of the cleaning solution A is performed both at the cooling tank 22 and at the auxiliary tank 40 because the return flow path 54 is passing through inside the cooling tank 22, and therefore, the cooling is performed more effectively.

The moving of the cleaning solution A from the cleaning bath 16 to the auxiliary tank 40 is controlled by the valve 56, and the moving of the cleaning solution A when the cleaning solution A is returned from the auxiliary tank 40 to the cleaning bath 16 is controlled by the high-temperature pump 55 or the compressed air introducing mechanism 47. The air pipe 48 is provided to evacuate the compressed air introduced into the auxiliary tank 40 when the cleaning solution A is moved, and gas having a possibility in which the vaporized cleaning solution A is contained flows into the cleaning bath 16 from the auxiliary tank 40 when the cleaning solution A is moved from the auxiliary tank 40 to the cleaning bath 16.

Note that the cleaning solution A may be moved manually from the auxiliary tank 40 to the cleaning bath 16 though the high-temperature pump 55 is used for the moving of the cleaning solution A at the circulation mechanism 50 because the cleaning solution A is in high-temperature.

Besides, FIG. 4 is an explanatory diagram illustrating an appearance of the cleaning solution A at the distillation and regeneration time at the cleaning system 1′. The distillation and regeneration of the cleaning solution A is performed at the cleaning system 1′ as same as the cleaning system 1 according to the above-stated embodiment. Here, it is possible to perform the distillation and regeneration of the cleaning solution A at the time other than the cleaning time of the work 5 at the cleaning system 1′, and in this case, the heating of the cleaning solution A is performed under a state in which the cleaning solution A is put in the cleaning bath 16 as illustrated in FIG. 4. As stated above, the temperature in which the vegetable cleaning solution (PAINTSOLV® manufactured by Infinity) is vaporized is approximately 178° C., and therefore, the cleaning solution A is heated at the cleaning bath 16 up to a higher-temperature (for example, from 200° C. to 280° C.) than the cleaning time when only the distillation and regeneration are performed. Note that the cleaning bath 16 is in the sealed state, and therefore, it is possible to easily heat the cleaning solution A up to the temperature equal to or higher than the boiling point.

As illustrated in FIG. 4, the cleaning solution A becomes the cleaning solution gas to be flowed out from the gas recovery hole 18 of the cleaning bath 16 to the distillation tube 21 resulting from the internal pressure of the cleaning bath 16 when the cleaning solution A is heated at the cleaning bath 16 up to the temperature in which the cleaning solution A is vaporized. The flowed out cleaning solution gas is cooled and becomes liquid at the distillation tube 21 in the cooling tank 22, and thereafter, stored in the distillation tank 23.

As stated above, when the cleaning of the work 5 to which the stains such as the coating cured film, the adhesive, or the like are adhered is performed, the cleaning solution A is circulated by the circulation mechanism 50, and thereby, it is possible to effectively perform the cooling of the work 5 after the cleaning and the cooling of the cleaning solution A after the cleaning in a short time at the cleaning system 1′ in addition to perform the effective cleaning of the work 5 and the distillation and regeneration of the cleaning solution A described in the above-stated embodiment.

Note that the water-cooling type is cited as the cooling method at the cooling tank 22 in the above-stated cleaning system 1, cleaning system 1′, but various cooling methods such as an air-cooling type are conceivable, and the distillation tube 21 passing through inside the cooling tank 22 may have a constitution increasing a surface area of the distillation tube 21, to quickly cool the distillation tube 21 in any cases. It is therefore conceivable that the shape of the distillation tube 21 may be, for example, a spiral state tube in addition to the illustrated shape. Besides, it is similarly conceivable that the shape of the return flow path 56 may be, for example, the spiral state tube in addition to the illustrated shape.

Besides, the PAINTSOLV® manufactured by Infinity is taken to be described as the vegetable cleaning solution, but the cleaning solution is not limited to the above in the present invention, and a cleaning solution which can be heated can be used as the cleaning solution. It is preferable that temperatures at the cleaning time and at the distillation and regeneration time in that case are to be set appropriately.

Further, in the above-described cleaning system 1, cleaning system 1′, it is conceivable as a matter of course that the distillation and regeneration are simultaneously performed with the high-temperature cleaning because the distillation and regeneration are performed under the state in which the cleaning object such as the work 5 is put into the cleaning bath 16. Besides, it goes without saying that the present invention can be applied to a cleaning of an adhered paint adhered to the work 5 under a state in which it is not completely solidified.

### Example

The vegetable cleaning solution (PAINTSOLV® manufactured by Infinity) is put into the cleaning bath (capacity: 20 liters) of the cleaning system illustrated in FIG. 2 according to the above-stated embodiment, and a work in which the UV paint is completely cured is actually put in and cleaned. The cleaning is performed under a condition in which the cleaning solution temperature is set at 178° C., and thereafter, the cleaning solution is cooled in the auxiliary tank until the temperature becomes equal to or lower than 50° C., and the work is brought out from the cleaning bath. As a result, the completely cured film of the UV paint which cannot be cleaned by using the vegetable cleaning solution at the conventional low-temperature, the thinner, or the like is almost completely cleaned, and an exposure of a metal surface can be fully verified.

Further, a bearing to which lithium grease being kinds of fats and oils and difficult to be cleaned is adhered is also cleaned under the same condition as the above. As a result, the lithium grease which is difficult to be cleaned is almost completely cleaned, and the exposure of the metal surface of the bearing can be fully verified as same as the above-stated work.

Note that conventionally, it takes approximately for five hours to perform the cleaning, but it is possible in this example to perform the cleaning of the work for total two hours in which one hour for the heating and one hour for the cleaning.

### INDUSTRIAL APPLICABILITY

The present invention can be applied to a cleaning system performing a cleaning of a work after, for example, UV paint or the like is completely dried by using a vegetable cleaning solution heated to a temperature equal to or higher than a flash point.

What is claimed:

1. A cleaning system cleaning paint adhered to a work, comprising:
a cleaning tank housing the work under a sealed state, and in which a cleaning solution is filled; and
a heater heating the cleaning solution filled in the cleaning tank to a temperature equal to or higher than a flash point of the cleaning solution.

2. The cleaning system according to claim 1, further comprising:
a distillation and regeneration mechanism distilling and regenerating the cleaning solution.

3. The cleaning system according to claim 1, further comprising:
a cooling tube cooling the cleaning solution filled in the cleaning tank.

4. The cleaning system according to claim 1, further comprising:
an auxiliary tank storing the cleaning solution; and
a circulation mechanism circulating the cleaning solution between the cleaning tank and the auxiliary tank.

5. The cleaning system according to claim 4,
wherein the circulation mechanism includes:
a forward flow path carrying the cleaning solution from the auxiliary tank to the cleaning tank; and
a return flow path carrying the cleaning solution from the cleaning tank to the auxiliary tank.

6. The cleaning system according to claim 4,
wherein the auxiliary tank is disposed at downward of the cleaning tank, and includes a solution sending mechanism carrying the cleaning solution from the auxiliary tank to the cleaning tank.
